(19) United States
(12) Patent Application Publication
(10) Pub. No.: US 2012/0263882 A1
(43) Pub. Date: Oct. 18, 2012

(54) RESIN-IMPREGNATED BASE SUBSTRATE AND METHOD FOR PRODUCING THE SAME

(75) Inventors: Satoshi Okamoto, Tsukuba-shi (JP); Shiro Katagiri, Tsukuba-shi (JP); Jongchul Seo, Tsukuba-shi (JP)

(73) Assignee: SUMITOMO CHEMICAL COMPANY, LIMITED, Tokyo (JP)

(21) Appl. No.: 13/531,815

(22) Filed: Jun. 25, 2012

Related U.S. Application Data
(62) Division of application No. 11/584,499, filed on Oct. 23, 2006.

(30) Foreign Application Priority Data
Oct. 26, 2005 (JP) 2005-310913

(51) Int. Cl. B05D 7/24; B05D 7/02; B05D 7/00; C03C 17/32

(52) U.S. Cl. 427/389.8; 427/385.5; 427/393.5; 427/393.6

(57) ABSTRACT

A resin-impregnated base substrate is provided by immersing a sheet in an aromatic liquid crystal polyester solution composition so that the polyester is impregnated into the sheet, and removing the solvent. The composition comprises 20 to 50 parts by weight of an aromatic liquid crystal polyester and 100 parts by weight of an aprotic solvent having no halogen atom, wherein the sheet comprises fiber selected from the group consisting of polyolefin resin fiber, fluorocarbon resin fiber, aramid resin fiber, glass fiber, ceramic fiber and carbon fiber.

### CROSS REFERENCE TO RELATED APPLICATIONS

This is a divisional application of U.S. application Ser. No. 11/584,499 filed Oct. 23, 2006, which claims benefit of Japanese Application No. 2005-310913 filed Oct. 26, 2005. The entire disclosure of the prior applications are hereby incorporated by reference.

### BACKGROUND OF THE INVENTION

1. Field of the Invention

The present invention relates to a resin-impregnated base substrate that is used in applications such as printed circuits and package substrates, and a method for producing the resin-impregnated base substrate.

2. Description of the Related Art

In recent years, it has been desired to develop an insulating resin base substrate which is used with an electric conducting layer in the electronics field.

Some methods for producing an insulating resin base substrate have been known. For example, an insulating resin base substrate has been produced by a method in which an epoxy resin is impregnated into glass cloth has been produced; or a method in which a glass powder filler is added to a cyanate resin and an epoxy resin (see, JP-A No. 2002-194121). However, the resin base substrate obtained by such a method is insufficient in electrical characteristics (such as low dielectric constant and low dielectric dissipation factor) and heat resistance.

On the other hand, a fiber-reinforced base substrate is known as a base substrate with good electrical characteristics and high dimensional stability. The fiber-reinforced base substrate is obtained by impregnating an aromatic liquid crystal polyester composition, in which an aromatic liquid crystal polyester is dissolved in a halogen-substituted phenol solvent, into a sheet base substrate and removing the solvent (see, JP-A No. 2004-244621). For improving this method, it has been desired to develop a method for producing a resin base substrate in which a halogen-type solvent is not needed, and a high-concentrated composition with low viscosity can be used in order to prevent from dripping and irregular adhesion of the resin composition and to avoid causing a defective appearance.

### SUMMARY OF THE INVENTION

One of objects of the present invention is to provide a resin-impregnated base substrate excellent in electrical characteristic in high frequency and heat resistance and dimensional stability, the base substrate being able to be produced by a method using no a halogen-type solvent and having good appearance even if the concentration of the resin composition used is used.

The present inventors have zealously investigated and consequently found a base substrate with such properties.

According to the present invention, a resin-impregnated base substrate without defective appearance and the irregular adhesion of a resin by dripping of the solution at the time of impregnating the resin can be obtained by the use of the aromatic liquid crystal polyester solution composition obtained by dissolving the high solid amount of the aromatic liquid crystal polyester in a solvent with high volatility and low boiling point. Moreover, it becomes possible to produce resin-impregnated base substrates with a little odor at the time of processing and good appearance continuously and stably.

In the field of the information and communication devices in recent years, since higher frequency applications are advancing, the resin-impregnated base substrate obtained by the present invention is suitable for use as an insulating resin substrate with small dielectric dissipation factor also in the high frequency region. Moreover, because a resin-impregnated base substrate with an electric conductive layer on at least one side of the resin-impregnated base substrate obtained by the present invention has low coefficient of linear expansion in addition to the characteristics of high heat resistance, it can be suitably used in a printed circuit, a modular substrate, and the like.

The present invention provides a base substrate obtainable by impregnating into a sheet an aromatic liquid crystal polyester solution composition which contains

(i) 20 to 50 parts by weight of an aromatic liquid crystal polyester having 30 to 50% by mole of structural unit shown by formula (a1) below, 25 to 35% by mole of structural unit shown by formula (a2) below and 25 to 35% by mole of structural unit shown by formula (a3) below,

—O—Ar₁—CO— (a1),

—CO—Ar₂—CO— (a2),

—X—Ar₃—Y— (a3),

Ar₁ indicating 1,4-phenylene, 2,6-naphthalene or 4,4′-biphenylene, Ar₂ indicating 1,4-phenylene, 1,3-phenylene or 2,6-naphthalene, Ar₃ indicating 1,4-phenylene or 1,3-phenylene, X indicating —NH—, and Y indicating —O— or —NH—,

each molar amount being on the basis of the total structural units of the polyester; and

(ii) 100 parts by weight of an aprotic solvent having no halogen atom,

wherein the sheet comprises at least one kind of fiber selected from the group consisting of polyolefin resin fiber, fluorocarbon resin fiber, aramid resin fiber, glass fiber, ceramic fiber and carbon fiber,

and removing the solvent.

The present invention also provides a method for producing the base substrate.

### DESCRIPTION OF THE PREFERRED EMBODIMENT

A base substrate in the present invention can be obtainabed by impregnating into a sheet an aromatic liquid crystal polyester solution composition. The aromatic liquid crystal polyester solution composition contains (i) 20 to 50 parts by weight of an aromatic liquid crystal polyester and (ii) 100 parts by weight of an aprotic solvent having no halogen atom.

The aromatic liquid crystal polyester in the present invention shows optical anisotropy and forms an anisotropy melt at a temperature of 450° C. or lower. The aromatic liquid crystal polyester has 30 to 50% by mole of structural unit shown by formula (a1) below, 25 to 35% by mole of structural unit shown by formula (a2) below and 25 to 35% by mole of structural unit shown by formula (a3) below,

—O—Ar₁—CO— (a1),

—CO—Ar₂—CO— (a2),

—X—Ar₃—Y— (a3),

Ar₁ indicating 1,4-phenylene, 2,6-naphthalene or 4,4′-biphenylene, Ar₂ indicating 1,4-phenylene, 1,3-phenylene or 2,6-naphthalene, Ar₃ indicating 1,4-phenylene or 1,3-phenylene, X indicating —NH—, and Y indicating —O— or —NH—,

each molar amount being on the basis of the total structural units of the polyester.

Structural unit (a1) is a structural unit derived from an aromatic hydroxycarboxylic acid, structural unit (a2) is a structural unit derived from an aromatic dicarboxylic acid, and structural unit (a3) is a structural unit derived from an aromatic diamine, an aromatic amine having a hydroxyl group or an aromatic amino acid. The structural units (a1), (a2) and (a3) can be provided using as raw materials for synthesis, ester-forming derivatives and/or amide-forming derivatives in place of using the aromatic hydroxycarboxylic acid, the aromatic dicarboxylic acid, the aromatic diamine, the aromatic amine having a hydroxyl group and/or the aromatic amino acid.

Examples of the ester-forming derivatives of the aromatic hydroxycarboxylic acid, the aromatic dicarboxylic acid and the aromatic amino acid for providing a carboxylic group include compounds in which the carboxylic group is converted to a derivative having a high reactivity and promoting a reaction for producing an ester group such as acid chloride, acid anhydride and the like; and compounds in which the carboxylic group forms an ester group with a lower alcohol, ethylene glycol or the like thus being converted to a derivative that forms an ester group by ester-exchange reaction (transesterification).

Examples of the ester-forming derivative of the aromatic hydroxycarboxylic acid, the aromatic amine having a hydroxyl group and the aromatic amino acid for providing a phenolic hydroxyl group include compounds in which the phenolic hydroxyl group forms an ester group with a carboxylic acid thus being converted to a derivative that forms an ester group by the ester-exchange reaction (transesterification).

Examples of the amide-forming derivative of the aromatic diamine, the aromatic amine having a hydroxyl group and the aromatic amino acid for providing an amide group include compounds in which the amino group forms an amide group with a carboxylic acid thus being converted to a derivative that forms an amide group by condensation reaction.

As described above, the liquid crystal polyester in the present invention may have the structural units represented by formulas (a1), (a2) and (a3), which are not limited thereto.

Examples of the structural unit represented by formula (a1) include structural units derived from p-hydroxybenzoic acid, 2-hydroxy-6-naphthoic acid and 4-hydroxy-4′-biphenylcarboxylic acid, and two kinds or more of the above-mentioned structural units may be contained in the liquid crystal polyester. Among these structural units, the structural unit derived from 2-hydroxy-6-naphthoic acid is preferably used in the liquid crystal polyester in the present invention.

On the basis of the total structural units in the polyester, the structural unit (a1) is contained in the polyester in the amount of 30 to 50% by mole, and preferably in the amount of 32.5 to 42.5% by mole. When the structural unit (a1) is contained in the polyester in the amount of larger than 50% by mole, the resulting polyester may have less solubility in a solvent. When the amount is smaller than 30% by mole, the polyester may show less liquid crystallinity.

Examples of the structural unit represented by formula (a2) include structural units derived from terephthalic acid, isophthalic acid and 2,6-naphthalenedicarboxylic acid, and two kinds or more of the above-mentioned structural units may be contained in the liquid crystal polyester. Among these structural units, the structural unit derived from isophthalic acid is preferably used in the liquid crystal polyester in the present invention from the viewpoint of the solubility of the liquid crystal polyester solution.

On the basis of the total structural units in the polyester, the structural unit (a2) is contained in the polyester in the amount of 20 to 35% by mole, and preferably in the amount of 27.5 to 32.5% by mole. When the structural unit (a2) is contained in the polyester in the amount of larger than 35% by mole, the resulting polyester may show less liquid crystallinity. When the amount is smaller than 25% by mole, the polyester may have less solubility in a solvent.

Examples of the structural units represented by formula (a3) include structural units derived from 3-aminophenol, 4-aminophenol, 1,4-phenylenediamine and 1,3-phenylenediamine, and two kinds or more of the above-mentioned structural units may be contained in the liquid crystal polyester. Among these structural units, the structural unit derived from 4-aminophenol is preferably used in the liquid crystal polyester in the present invention from the viewpoint of the reactivity.

On the basis of the total structural units in the polyester, the structural unit (a3) is contained in the polyester in the amount of 25 to 35% by mole, and preferably in the amount of 27.5 to 32.5% by mole. When the structural unit (a3) is contained in the polyester in the amount of larger than 35% by mole, the resulting polyester may show less liquid crystallinity. When the amount is smaller than 25% by mole, the polyester may have less solubility in a solvent.

For producing a liquid crystal polyester in the present invention, a raw material for structural unit (a3) is preferably used in about the same amount as of a raw material for structural unit (a2). For example, the raw material for structural unit (a3) is preferably used in the amount of from 0.9 times to 1.1 times as large as the amount of the raw material for structural unit (a2). In this case, polymerization degree of the resulting liquid crystal polyester can be easily controlled.

A method for producing a liquid crystal polyester in the present invention is not limited. Examples of the method include a method in which a phenolic hydroxyl group or an amino group of an aromatic hydroxycarboxylic acid for structural unit (a1), an aromatic amine and an aromatic diamine having a hydroxyl group for structural unit (a3) is acylated with an excessive amount of a fatty acid anhydride to obtain an acyl compound corresponding thereto, and then transesterification (polycondensation) in melt-phase-condensation of the thus-obtained acyl compound and an aromatic dicarboxylic acid for structural unit (a2) is conducted. Alternatively, a fatty acid ester obtained in advance by acylation may be used as the acyl compound (see, JP-A Nos. 2002-220444 and 2002-146003).

In the acylation reaction, the fatty acid anhydride is preferably used in the amount of 1.0 to 1.2 times by weight, more preferably in the amount of 1.05 to 1.1 times by weight, on the basis of the total amount of the phenolic hydroxyl group and/or amino group to be reacted. When the amount of the fatty acid anhydride is smaller than 1.0 times, the acyl compound and the raw material monomer may sublimate at the time of the transesterification (polycondensation), and the reaction system tends to be easily blocked up. When the amount is larger than 1.2 times, coloration of the resulting liquid crystal polyester tends to be observed.

The acylation reaction is preferably carried out at a temperature of 130 to 180° C. for five minutes to ten hours, and is more preferably carried out at a temperature of 140 to 160° C. for ten minutes to three hours.

The fatty acid anhydride used in the acylation reaction is not limited. Examples of the fatty acid anhydride include acetic anhydride, propionic anhydride, butylic anhydride, isobutylic anhydride, valeric anhydride, pivalic anhydride, 2-ethyl hexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride. These fatty acid anhydrides may be used as the mixture of two kinds or more of them. Among these, acetic anhydride, propionic anhydride, butylic anhydride and isobutylic anhydride are preferable from the viewpoint of the price and handle-ability, and acetic anhydride is more is preferable.

In the polymerization by the transesterification and the transamidation, the acyl group of the acyl compound is preferable to be 0.8 to 1.2 times equivalent weight of carboxyl group.

The polymerization by transesterification and transamidation is preferably carried out at a temperature of 130 to 400° C. while the temperature is raised at the rate of 0.1 to 50° C./minute, and is more preferably carried out at a temperature of 150 to 350° C. while the temperature is raised at the rate of 0.3 to 5° C./minute.

When the transesterification of an acyl compound and a carboxylic acid is conducted, the fatty acid generated as a by-product and the unreacted fatty acid anhydride are preferably distilled and removed outside the reaction system by being vaporized in order to move the equilibrium.

The acylation reaction and the polymerization by transesterification and transamidation may be carried out in the presence of a catalyst. The catalyst may be conventionally-used one. Examples of the catalyst include metal salt catalysts such as magnesium acetate, stannous acetate, tetrabutyl titanate, lead acetate, sodium acetate, potassium acetate and antimony trioxide; and organic compound catalysts such as N,N-dimethylaminopyridine and N-methyl imidazole.

Among these catalysts, heterocyclic compounds containing two or more nitrogen atoms such as N,N-dimethylaminopyridine and N-methylimidazole are preferably used (see, JP-A No. 2002-146003).

The catalyst may be used together with monomers as raw materials for the acylation, and does not necessarily need to be removed after the acylation, which can be followed by polymerization by transesterification and/or transamidation to produce a liquid crystal polyester.

Polycondensation by transesterification and/or transamidation may be melt polymerization or may be melt polymerization followed by solid-state polymerization. The solid-state polymerization may be conducted in a method in which a pre-polymer obtained by a melt polymerization is crushed to prepare a powder-like or flake-like pre-polymer, which is then polymerized by a solid-state polymerization (which may be a known polymerization). Specifically, for example, such a method can be conducted in a way that heat treatment of the crushed pre-polymer is conducted in a solid-state under the inert atmosphere such as nitrogen atmosphere at a temperature of 20 to 350° C. for 1 to 30 hours. The solid-state polymerization may be conducted while the crushed pre-polymer is stirred, or may be conducted while leaving the crushed pre-polymer at rest without stirring. The melt polymerization and the solid-state polymerization may be conducted in one reaction tank installed with a suitable stir means. After the solid-state polymerization, the resulting liquid crystal polyester may be pelletized and shaped by known methods.

The production of the liquid crystal polyester can be conducted using, for example, a batch apparatus, a continuous apparatus and the like.

Provided that properties of the liquid crystal polyester are not impaired, the liquid crystal polyester may contain one or more kinds of a thermoplastic resin such as polypropylene, polyamide, polyester, polyphenylene sulfide, polyether ketone, polycarbonate, polyether sulfone, polyphenylether and its denatured product and polyether imide, an elastomer such as copolymer of glycidyl methacrylate and ethylene, and the like.

The flow-beginning temperature of the liquid crystal polyester is not limited, and may be about 200° C. or higher. The flow-beginning temperature can be measured as a temperature at which the liquid crystal polyester has a viscosity of 4800 Pa·s or lower under the pressure of 9.8 MPa in a measurement of melt viscosity of the liquid crystal polyester by flow tester. In the field of liquid crystal polyester, it is generally known that such a flow-beginning temperature corresponds to the molecular weight of the polyester and can be used as an indication of the molecular weight.

In the present invention, the flow-beginning temperature is preferably in the range of from 220° C. to 340° C., and is more preferably in the range of from 260° C. to 300° C. When the liquid crystal polyester has a flow-beginning temperature of 220° C. or higher, the adhesion of the polyester to a sheet tends to more improved. When the liquid crystal polyester has a flow-beginning temperature of 340° C. or lower, the polyester tends to have a higher solubility in a solvent.

In the aromatic liquid crystal polyester solution composition in the present invention, 20 to 50 parts by weight of the above-described aromatic liquid crystal polyester and 100 parts by weight of an aprotic solvent having no halogen atom.

Examples of the aprotic solvents include ether solvents such as diethyl ether, tetrahydrofuran, and 1,4-dioxane, ketone solvents such as acetone and cyclohexanone, ester solvents such as ethyl acetate, lactone solvents such as γ-butyrolactone, carbonate solvents such as ethylene carbonate and propylene carbonate, amine solvents such as triethylamine and pyridine, nitrile solvents such as acetonitrile and succinonitrile, amide solvents such as N,N-dimethylformamide, N,N-dimethylacetamide, tetramethylurea, and N-methylpyrrolidone, nitro solvents such as nitromethane and nitrobenzene, sulfide solvents such as dimethylsulfoxide and sulfolane, and phosphoric acid solvents such as hexamethylphosphoramide and tri n-butyl phosphate.

Among these solvents, it is preferred to use a solvent having a dipole moment of from 3 to 5 from the viewpoint of solubility, the solvent more preferably having a boiling point of 180° C. or lower (which tends to be easily evaporated). Examples of such a preferable solvent include amide solvents such as N,N-dimethylformamide, N,N-dimethylacetamide, tetramethylurea, and N-methylpyrrolidone, and lactone solvents such as γ-butyrolactone. Among them, N,N-dimethylformamide, N,N-dimethylacetamide, or N-methylpyrrolidone are more preferably used, and N,N-dimethylformamide or N,N-dimethylacetamide is most preferably used.

In the present invention, it is preferred to use an aromatic liquid crystal polyester solution composition containing the above-mentioned aromatic liquid crystal polyester in the aprotic solvent with high volatility and low boiling point. By using such a liquid crystal polyester solution composition, a resin-impregnated base substrate with a little defective appearance and a little uneven thickness can be provided, because the dripping of the solution composition at the time of producing the base substrate can be suppressed.

In the aromatic liquid crystal polyester solution composition in the present invention, the aromatic liquid crystal polyester is contained in the amount of from 20 to 50 parts by weight, and preferably in the amount of from 25 to 40 parts by weight, on the basis of 100 parts by weight of the above-mentioned aprotic solvent.

When the aromatic liquid crystal polyester is smaller than 20 parts by weight, it may be difficult that the proper quantity of the polyester in the resulting solution composition adhere easily to a sheet. Moreover, because the part of the solvents is large, the defective appearance may be easily caused by the dripping of the solution composition at the time of drying to remove the solvent. When the aromatic liquid crystal polyester is larger than 50 parts by weight, the resulting solution composition tends to have a high viscosity, which may cause twisting of a sheet at the time of impregnating the polyester solution composition into the sheet. In such a case, the irregular adhesion of the polyester to the sheet may easily occur. In terms of the balance between the solid content of the polyester and the solution viscosity, the aromatic liquid crystal polyester is more preferably 25 to 40 parts by weight on the basis of 100 parts by weight of the aprotic solvent, as mentioned above.

It is said that, although a liquid crystal polyester solution composition with a high resin concentration has been generally required at the time of producing a resin-impregnated base substrate, it has been difficult to make the high-concentration solution composition because a liquid crystal polyester resin does not dissolve easily in a solvent. The aromatic liquid crystal polyester solution composition used in the present invention, however, is an aromatic liquid crystal polyester solution composition with a high resin concentration obtained by dissolving the above-mentioed liquid crystal polyester in an aprotic solvent. The solution composition can suppress the dripping of the composition and the irregular adhesion of the polyester to a sheet, thereby providing a resin-impregnated base substrate excellent in appearance continuously and stably. Moreover, there is a little odor at the time of processing.

The aromatic liquid crystal polyester solution composition in the present invention can be obtained by dissolving the above-mentioned aromatic liquid crystal polyester in the above-mentioned aprotic solvent. After the dissolving, the solution composition is preferably filtered with a filter or the like to remove minute foreign matters contained in the solution composition, if needed.

In order to improve dimensional stability, thermal conductivity, electrical characteristics and the like of the resulting base substrate, the liquid crystal polyester may contain one or more kinds of a filler, an additive and the like provided that properties of the polyester are not impaired. Examples of the filler include inorganic fillers such as silica, alumina, titanium oxide, barium titanate, strontium titanate, aluminum hydroxide, and calcium carbonate; and organic fillers such as hardened epoxy resin, crosslinked benzoguanamine resin and crosslinked acrylic polymer. Examples of the additive and the like include thermoplastic resins such as polyamide, polyester, polyphenylene sulfide, polyether ketone, polycarbonate, polyether sulfone, polyphenylether and its denatured products, and polyether imide, thermosetting resins such as phenol resin, epoxy resin, polyimide resin, and isocyanate resin, and various additives such as silane coupling agents, antioxidants, and ultraviolet ray absorption agent.

A base substrate in the present invention can be produced by immersing a sheet in the above-mentioned aromatic liquid crystal polyester solution composition so that the polyester is impregnated into the sheet, and removing the solvent in the solution composition. Examples of the sheet include sheet comprising at least one kind of resin fiber selected form polyolefin resin fiber, fluorocarbon resin fiber, aramid resin fiber; glass fiber; ceramic fiber; and carbon fiber. Examples of the polyolefin resin fiber include polyethylene fiber and polypropylene fiber. Examples of fluorocarbon resin fiber include tetrafluoroethylene fiber. Examples of the glass fiber include alkali glass fiber, non-alkali glass fiber and low dielectric glass fiber. Examples of the ceramic fiber include alumina fiber and silicone fiber. Examples of the carbon fiber include polyacrylonitrile carbon fiber and pitch carbon fiber.

The sheet in the present invention may be fabric, knitted good or nonwoven fabric, which is made from the above-mentioned fiber. The surface of the fiber used may be treated with a coupling agent such as an amino silane coupling agent, an epoxy silane coupling agent and a titanate coupling agent.

In the present invention, the glass fiber sheet and resin fiber sheet are preferable, and among them, a sheet obtained from glass fiber is more preferable.

The sheet can be obtained, for example, by weaving the above-described fibers. Examples of weaving fibers include plain weave, satin weave, twill weave and basket weave. The sheet preferably has a weaving density of from 10 to 100 pieces/25 mm and a mass density of from 10 to 300 g/m². The thickness of the sheet may be in the range of from about 5 to 500 μm, and is preferably in the range of from about 20 to 200 μm, and is more preferably in the range of from about 30 to 100 μm.

As mentioned above, the resin-impregnated base substrate in the present invention can be obtained by impregnating an aromatic liquid crystal polyester solution into a sheet and drying to remove the solvent.

A method for removing the solvent is not limited to. Preferably, the solvent is removed by evaporation. Examples of the method for evaporating the solvent include heating, depressurizing and ventilation. The obtained resin-impregnated base substrate may be subjected to a heat treatment, if needed.

The base substrate may be used alone or may be used after laminating other sheets, films or the like thereon. The laminating method is not limited to, and may include the method of bonding other sheets, films or the like to the base substrate with an adhesive, and the method of heat-sealing them by heat pressing. Examples of such other sheets and films include metal films and resin films.

The base substrate obtained can be used with an electric conductive layer to provide a laminate of the substrate in a way that at least one electric conductive layer(s) is/are laminated on one side or both sides of the at least one base substrate.

Onto the laminated base substrate with electric conductive layer (s), another laminated base substrate may be superimposed thereon.

The laminating can be conducted in a way such that a metal film (foil) is laminated on the substrate, or that the substrate is coated with metal powder or particles so as to form an electric conductive layer on the substrate. Examples of the metal include copper, aluminum, and silver. Copper is preferably used from the viewpoints of electric conductivity and cost.

When the metal film (foil) is laminated on the substrate, the lamination can be conducted by a method of bonding the metal film (foil) and the substrate with an adhesive, or in a method of heat-sealing them by heat pressing. When the metal powder or particles is coated, a plating method, a screen-printing method, a sputtering method or the like can be conducted.

Onto the base substrate with an electric conductive layer, wiring a pattern may be formed to provide a circuit board, which can be preferably used as a printed circuit substrate and a module substrate in which two or more substrates may be contained. A resin film such as a cover film may be further laminated on the substrate for the purpose of protecting the electric conductive layer and the like.

In the field of information and communication devices in recent years, high frequency has been needed. Under such a circumstance, the base substrate of the present invention is suitable for use as an insulating resin substrate with small dielectric dissipation factor also in the high frequency region. Moreover, the base substrate with the electric conductive layer can be suitably used in a printed circuit, a modular substrate and the like, because the base substrate with the electric conductive layer has low coefficient of linear expansion in addition to the characteristic of high heat resistance.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2005-310913 filed on Oct. 26, 2005 including specification, claims and summary, are incorporated herein by reference in their entirety.

### EXAMPLES

The present invention is described in more detail by following Examples, which should not be construed as a limitation upon the scope of the present invention.

### Example 1

### (1) The Preparation of Aromatic Liquid Crystal Polyester

In a reactor equipped with a stirring device, a torque meter, a nitrogen gas introduction tube, a thermometer, and a reflux condenser, 376 g (2 mol) of 2-hydroxy-6-naphthoic acid, 1934 g (14 mol) of p-hydroxybenzoic acid, 1814 g (12 mol) of 4-hydroxyacetanilide, 1994 g (12 mol) of isophthalic acid, and 3267 g (32 mol) of acetic anhydride were put in. After the reactor inside was substituted enough with nitrogen gas, the temperature within the reactor was raised to 150° C. in 15 minutes under the flow of nitrogen gas, and the liquid within the reactor was refluxed for three hours while the temperature was maintained.

After that, the temperature was raised to 300° C. in 170 minutes while distilled by-product acetic acid and unreacted acetic anhydride were removed, and when the rise of the torque was admitted, the reaction was considered to be ended and the content was taken out. The taken out content was cooled to room temperature and then crushed with a coarse crusher, and thus aromatic liquid crystal polyester powder was obtained. It could be confirmed with a polarizing microscope that the obtained aromatic liquid crystal polyester powder showed the schlieren pattern, which is peculiar to the liquid crystalline phase, at 220° C.

The flow-beginning temperature of the aromatic liquid crystal polyester powder was measured using Flow Tester CFT-50 (manufactured by Shimadzu Corporation). As a result, the flow-beginning temperature was 265° C.

### (2) The Preparation of an Aromatic Liquid Crystal Polyester Solution

Out of the aromatic liquid crystal polyester powder obtained by the above-mentioned step, 2500 g was added to 7500 g of N,N-dimethylacetamide (DMAc) andheated to 100° C., and thus an aromatic liquid crystal polyester solution composition was obtained. The solution viscosity was 170 cP (at 23° C.)

### (3) The Preparation of a Resin-Impregnated Base Substrate

The aromatic polyester solution composition obtained in the above-mentioned preparation (2) was impregnated into the glass cloth (manufactured by Arisawa Mfg Co., Ltd.; the thickness is 50 μm), and the solvent was evaporated with a hot-air dryer on condition of 160° C. in preset temperature and a resin-impregnated base substrate was obtained. As for the obtained resin-impregnated base substrate, the amount of the resin adhered to the glass cloth was about 60% by weight, the thickness was 87±2 μm (the thickness distribution in the direction of the width of the base substrate), and the dispersion of the thickness was 2%. Defective appearance and resin irregular adhesion by dripping were hardly seen in the obtained resin-impregnated base substrate.

### (4) The Evaluation of the Resin-Impregnated Base Substrate

After that, the resin-impregnated base substrate was heat-treated at 300° C. for 20 minutes under the nitrogen atmosphere with a hot-air dryer. When on the sheet after the heat treatment, the dielectric constant and the dielectric dissipation factor were measured using an impedance analyzer manufactured by HP, the dielectric constant was 3.8 (1 GHz) and the dielectric dissipation factor was 0.006 (1 GHz).

The obtained aromatic liquid crystal polyester resin-impregnated base substrate was dipped in a soldering bath of 280° C. in soldering temperature for one minute and the surface state was observed. Neither deformation nor swelling was observed in the resin-impregnated base substrate.

Moreover, when on the obtained resin-impregnated base substrate, the coefficients of linear expansion in the direction of the plane and the direction of the thickness were evaluated with TMA apparatus (manufactured by Rigaku Coporation), the coefficient of linear expansion in the direction of the plane was 11 ppm/° C. (the temperature range: 50 to 100° C.).

### (5) Giving an Electric Conductive Layer to a Resin-Impregnated Base Substrate

Two sheets of the resin-impregnated base substrates obtained as described above were piled together and then copper foil (manufactured by Mitsui Mining And Smelting Company, Limited; 3EC-VLP (18 μm)) was laminated on the both side. The obtained laminate was integrated by being heated and pressed with a high-temperature vacuum press machine (manufactured by Kitagawa Seiki Co., Ltd.) under the conditions of 340° C., 20 minutes and 6 MPa, and a resin-impregnated base substrate with electric conductive layers was obtained.

The adhesion between the substrate and electric conductive layers (copper foils) was evaluated by a peel strength using Autograph AG-IS (manufactured by Shimadzu Corporation). Is noted that the peel strength was measured under the conditions where the copper foil was peeled off from the substrate at an angle of 90° therebetween at a peeling rate of 50 mm/min.

### Example 2

### (1) The Preparation of Aromatic Liquid Crystal Polyester

In a reactor equipped with a stirring device, a torque meter, a nitrogen gas introduction tube, a thermometer, and a reflux condenser, 1976 g (10.5 mol) of 2-hydroxy-6-naphthoic acid, 1474 g (9.75 mol) of 4-hydroxyacetanilide, 1620 g (9.75 mol) of isophthalic acid, and 2374 g (23.25 mol) of acetic anhydride were put in. After the reactor inside was substituted enough with nitrogen gas, the temperature within the reactor was raised to 150° C. in 15 minutes under the flow of nitrogen gas, and the liquid within the reactor was refluxed for three hours while the temperature was maintained.

After that, the temperature was raised to 300° C. in 170 minutes while distilled by-product acetic acid and unreacted acetic anhydride were removed, and when the rise of the torque was admitted, the reaction was considered to end and the content was taken out. The taken out content was cooled to room temperature and then crushed with a coarse crusher, and thus aromatic liquid crystal polyester powder was obtained. It could be confirmed with a polarizing microscope that the obtained aromatic liquid crystal polyester powder showed the schlieren pattern, which is peculiar to the liquid crystalline phase, at 220° C.

The flow-beginning temperature of the aromatic liquid crystal polyester powder was measured using Flow Tester CFT-50 (manufactured by Shimadzu Corporation). As a result, the is flow-beginning temperature was 235° C.

### (2) The Preparation of an Aromatic Liquid Crystal Polyester Solution

Out of the aromatic liquid crystal polyester powder obtained by the above-mentioned step, 2500 g was added to 7500 g of N,N-dimethylacetamide (DMAc) and heated to 100° C., and thus an aromatic liquid crystal polyester solution composition was obtained. The solution viscosity was 130 cP (at 23° C.)

### (3) The Preparation of a Resin-Impregnated Base Substrate

The aromatic polyester solution composition obtained in the above-mentioned preparation (2) was impregnated into the glass cloth (manufactured by Arisawa Mfg Co., Ltd.; the thickness is 50 μm), and the solvent was evaporated with a hot-air dryer on condition of 160° C. in preset temperature and a resin-impregnated base substrate was obtained. As for the obtained resin-impregnated base substrate, the amount of the resin adhered to the glass cloth was about 60% by weight, the thickness was 90±3 μm (the thickness distribution in the direction of the width of the base substrate), and the dispersion of the thickness was 3%. Defective appearance and resin irregular adhesion by dripping were hardly seen in the obtained resin-impregnated base substrate.

### (4) The Evaluation of the Resin-Impregnated Base Substrate

After that, the resin-impregnated base substrate was heat-treated at 300° C. for 20 minutes under the nitrogen atmosphere with a hot-air dryer. When on the sheet after the heat treatment, the dielectric constant and the dielectric dissipation factor were measured using an impedance analyzer (manufactured by HP), the dielectric constant was 3.9 (1 GHz) and the dielectric dissipation factor was 0.004 (1 GHz).

The obtained aromatic liquid crystal polyester resin-impregnated base substrate was dipped in a soldering bath of 280° C. in soldering temperature for one minute and the surface state was observed. Neither deformation nor swelling was observed in the resin-impregnated base substrate.

Moreover, when on the obtained resin-impregnated base substrate, the coefficient of linear expansion in the direction of the plane and the direction of the thickness was evaluated with TMA apparatus (manufactured by Rigaku Coporation), the coefficient of linear expansion in the direction of the plane was 12 ppm/° C. (the temperature range: 50 to 100° C.)

### (5) Giving an Electric Conductive Layer to a Resin-Impregnated Base Substrate

Two sheets of the resin-impregnated base substrates obtained as described above were piled together and then copper foil (3EC-VLP, manufactured by Mitsui Mining And Smelting Company, Limited (18 μm)) was laminated on the both side. The obtained laminate was integrated by being heated and pressed with a high-temperature vacuum press machine (manufactured by Kitagawa Seiki Co., Ltd.) under the conditions of 340° C., 20 minutes and 6 MPa, and a resin-impregnated base substrate with electric conductive layers was obtained.

The adhesion between the substrate and electric conductive layers (copper foils) was evaluated by a peel strength in the same manner as mentioned in Example 1.

### Comparative Example 1

### (1) The Preparation of Aromatic Liquid Crystal Polyester

In a reactor equipped with a stirring device, a torque meter, a nitrogen gas introduction tube, a thermometer, and a reflux condenser, 1035.0 g (5.5 mol) of 2-hydroxy-6-naphthoic acid, 512.1 g (2.75 mol) of 4,4′-dihydroxybiphenyl, 456.9 g (2.75 mol) of isophthalic acid, and 1235.3 g (12.1 mol) of acetic anhydride were put in. After the reactor inside was substituted enough with nitrogen gas, the temperature within the reactor was raised to 150° C. in 15 minutes under the flow of nitrogen gas, and the liquid within the reactor was refluxed for three hours while the temperature was maintained.

After that, the temperature was raised to 320° C. in 170 minutes while distilled by-product acetic acid and unreacted acetic anhydride were removed, and when the rise of the torque was admitted, the reaction was considered to be ended and the content was taken out. The obtained solid content was cooled to room temperature and then crushed with a coarse crusher. After that, the crushed product was held at 250° C. for three hours under the nitrogen atmosphere, and the polymerization reaction was advanced in the solid state.

The flow-beginning temperature of the aromatic liquid crystal polyester powder was measured using Flow Tester CFT-50 (manufactured by Shimadzu Corporation). As a result, the flow-beginning temperature was 300° C.

### (2) The Preparation of an Aromatic Liquid Crystal Polyester Solution

Out of the aromatic liquid crystal polyester powder obtained by the above-mentioned step, 800 g was added to 9300 g of p-chlorophenol (PCP) and heated to 120° C. As a result, it was confirmed that the solution in which the polyester powder had been completely dissolved could be obtained. The solution viscosity was 3000 cP (50° C.)

### (3) The Preparation of a Resin-Impregnated Base Substrate

The aromatic polyester solution composition obtained in the above-mentioned preparation (2) was impregnated into the glass cloth (manufactured by Arisawa Mfg Co., Ltd.; the thickness is 50 μm), and the solvent was evaporated with a hot-air dryer on condition of 160° C. in preset temperature and a resin-impregnated base substrate was obtained. As for the obtained resin-impregnated base substrate, the amount of the resin adhered to the glass cloth was about 60% by weight, the thickness was 91±8 μm (the thickness distribution in the direction of the width of the base substrate), and the is dispersion of the thickness was 9%. Defective appearance and resin irregular adhesion by dripping were observed in the obtained resin-impregnated base substrate. Moreover, the odor during drying to remove the solvent was harsh.

After that, the resin-impregnated base substrate was heat-treated at 300° C. for 20 minutes under the nitrogen atmosphere with a hot-air dryer. An aromatic liquid crystal polyester resin-impregnated base substrate was obtained. When the dielectric constant and the dielectric dissipation factor were measured on the sheet using an impedance analyzer (manufactured by HP), the dielectric constant was 3.9 (1 GHz) and the dielectric dissipation factor was 0.001 (1 GHz).

The obtained aromatic liquid crystal polyester resin-impregnated base substrate was dipped in a soldering bath of 280° C. in soldering temperature for one minute and the surface state was observed. Neither deformation nor swelling was observed in the resin-impregnated base substrate.

Further, when on the obtained resin-impregnated base substrate, the coefficient of linear expansion in the direction of the plane and the direction of the thickness was evaluated with TMA apparatus (manufactured by Rigaku Coporation), the coefficient of linear expansion in the direction of the plane was 24 ppm/° C. (the temperature range: 50 to 100° C.)

### Comparative Example 2

Out of the aromatic liquid crystal polyester powder obtained by Example 1, 1500 g was added to 8500 g of N,N-dimethylacetamide (DMAc) and heated to 100° C., and thus an aromatic liquid crystal polyester solution composition was obtained. The solution viscosity was 20 cP (at 23° C.)

The above-mentioned aromatic polyester solution composition was impregnated into the glass cloth (manufactured by Arisawa Mfg Co., Ltd.; the thickness is 50 μm) similarly to Examples, and the solvent was evaporated with a hot-air dryer on condition of 160° C. in preset temperature and a resin-impregnated base substrate was obtained. As for the obtained resin-impregnated base substrate, the amount of the resin adhered to the glass cloth was as low as about 20% by weight, and the proper amount of the resin could not be adhered to the base substrate. The thickness of the resin-impregnated base substrate was 64±9 μm (the thickness distribution in the direction of the width of the base substrate), the dispersion of the thickness was 13%, and defective appearance and resin irregular adhesion by dripping were observed.

| | | | Comparative | Comparative |
|---|---|---|---|---|
| | Example 1 | Example 2 | Example 1 | Example 2 |
| Solvent | DMAc | DMAc | PCP | DMAc |
| Flow-beginning | 265° C. | 235° C. | 300° C. | 265° C. |
| temperature | | | | |
| The solid amount | 25 | 25 | 8 | 15 |
| of resin (%) | | | | |
| Solution | 170 (at | 130 (at | 3000 (at | 20 (at |
| viscosity (cP) | 23° C.) | 23° C.) | 50° C.) | 23° C.) |
| The amount of the | 60 | 60 | 60 | 20 |
| resin adhered (%) | | | | |
| Surface | Good | Good | Vertically | Vertically |
| appearance | | | striped | striped |
| | | | pattern was | pattern was |
| | | | Observed | Observed |
| <The thickness | | | | |
| distribution of | | | | |
| the base | | | | |
| substrate>; | | | | |
| Average | 87 | 90 | 91 | 64 |
| thickness (μm); | | | | |
| Distribution (%) | 2 | 3 | 9 | 13 |
| Peel strength of | 9.6 | 7.9 | — | — |
| Cu foil (N/cm) | | | | |

What is claimed is:

1. A method for producing a base substrate, the method comprising the steps of:
dissolving, into 100 parts by weight of an aprotic solvent having no halogen atom, 20 to 50 parts by weight of an aromatic liquid crystal polyester having 30 to 50% by mole of structural unit shown by formula (a1) below, 25 to 35% by mole of structural unit shown by formula (a2) below and 25 to 35% by mole of structural unit shown by formula (a3) below,
—O—Ar₁—CO— (a1),
—CO—Ar₂—CO— (a2),
—X—Ar₃—Y— (a3),
Ar₁ indicating 1,4-phenylene, 2,6-naphthalene or 4,4′-biphenylene, Ar₂ indicating 1,4-phenylene, 1,3-phenylene or 2,6-naphthalene, Ar₃ indicating 1,4-phenylene or 1,3-phenylene, X indicating —NH—, and Y indicating —O— or —NH—,
each molar amount being on the basis of the total structural units of the polyester;
impregnating the resulting solution composition into a sheet which has a thickness of from about 5 to about 500 μm and comprises at least one kind of fiber selected from the group consisting of polyolefin resin fiber, fluorocarbon resin fiber, aramid resin fiber, glass fiber, ceramic fiber and carbon fiber; and
removing the solvent,
wherein the aromatic liquid crystal polyester has a flow-beginning temperature of from 220 to 340° C.

2. The method for producing a base substrate according to claim 1, wherein the sheet is a sheet obtained from glass fiber.

3. The method for producing a base substrate according to claim 1, wherein the aprotic solvent has a dipole moment of from 3 to 5 and a boiling point of 180° C. or lower.

4. The method for producing a base substrate according to claim 1, wherein the aromatic liquid crystal polyester has a flow-beginning temperature of from 260 to 300° C.

5. The method for producing a base substrate according to claim 2, wherein the aromatic liquid crystal polyester has a flow-beginning temperature of from 260 to 300° C.

6. The method for producing a base substrate according to claim 2, wherein the aromatic liquid crystal polyester has a flow-beginning temperature of from 260 to 300° C. and the aprotic solvent is a solvent selected from the group consisting of N,N-dimethylformamide, N,N-dimethylacetamide and N-methylpyrrolidone.

7. The method for producing a base substrate according to claim 2, wherein the aromatic liquid crystal polyester has a flow-beginning temperature of from 260 to 300° C. and N,N-dimethylformamide is used as the aprotic solvent.
